(19) United States
(12) Patent Application Publication
(10) Pub. No.: US 2004/0208979 A1
(43) Pub. Date: Oct. 21, 2004

(54) Foodstuff profile

(75) Inventors: Andrew T. Miller, Leicestershire (GB); Sandy M. Bollengier-Lee, St. Denis De L'Hotel (FR); Simon R. Hall, Leicestershire (GB)

Correspondence Address: FULBRIGHT & JAWORSKI, LLP, 1301 MCKINNEY, SUITE 5100, HOUSTON, TX, 77010-3095, US

(73) Assignee: Mars UK Limited, Slough (GB)

(21) Appl. No.: 10/742,224

(22) Filed: Dec. 19, 2003

(30) Foreign Application Priority Data
Dec. 20, 2002 (GB) 0229842.0
Dec. 20, 2002 (GB) 0229838.8
Dec. 20, 2002 (GB) 0229839.6
Sep. 4, 2003 (GB) 0320729.7

(51) Int. Cl. A23J 1/00

(52) U.S. Cl. 426/656

(57) ABSTRACT

The present invention relates to a method of ensuring acceptance of a foodstuff to said cat by providing said foodstuff with specific macronutrient content parameters. The present invention provides a method of ensuring the acceptance of a foodstuff to a cat, the method comprising feeding to said cat, a foodstuff having a protein:energy ratio of from 40 to 60%, a carbohydrate:energy ratio of 25% or less and a fat:energy ratio of from 15 to 60%, wherein the energy ratios are based on the total energy content of the foodstuff.

### CROSS-REFERENCE TO RELATED APPLICATIONS

This application claims priority to UK Application No. 0229842.0 filed Dec. 20, 2002; UK Application No. 0229838.8 filed Dec. 20, 2002; UK Application No. 0229839.6 filed Dec. 20, 2002; and UK Application No. 0320729.7 filed Sep. 4, 2003.

### TECHNICAL FIELD

The present invention relates to a method of ensuring acceptance of a foodstuff to said cat by providing said foodstuff with specific macronutrient content parameters.

### BACKGROUND OF THE INVENTION

This invention is based on the observation that when consuming food, animals are attempting to reach a target intake of each of the three macronutrients (protein, carbohydrate, fat) within a given time period.

This invention addresses the problem of providing palatable foods for feline animals, while also offering health benefits to the animal and, in particular, an increased acceptance/increased enjoyment in feeding.

Historically, the majority of research work on “palatability” (the relative acceptance of and preference for different foods) has concentrated on optimising the organoleptic qualities of the food. The assumption has been that the acceptability of a food and preference for one food over another are primarily driven by the taste and texture of the food. The assumption has been that as long as the nutrient content of foods exceed the minimum requirements of the animal, it will not discriminate between diets of differing nutrient profile unless there is an indirect effect on the taste or texture of the diets. This invention is based on data that demonstrates that this is not the case. When given the opportunity to do so, by provision of foods of different macronutrient contents, the animals will select between these foods so as to regulate their consumption of each macronutrient in order to reach an optimum ratio.

The present invention has identified that there is a limit to the amount of carbohydrate that cats will accept in their preferred foodstuff. It has also identified that there is a careful balance of energy ratios, contributed by the three macronutrient ingredients, which cats find the most enjoyable/acceptable.

Different animals, including different species and breeds of animal will have different optimum macronutrient content for their diets. Furthermore, an individual animal is likely to have, within a range, a changing optimum macronutrient content of their diet, depending on factors such as life stage, sex, sexual activity, illness, seasonal variation, environment, stress levels etc.

The present invention selects, from known foodstuffs, for known animals, a specific range of macronutrients which are most preferred by cats, in general.

### BRIEF SUMMARY OF THE INVENTION

Accordingly, the present invention provides a method of ensuring the acceptance of a foodstuff to a cat, the method comprising feeding to said cat, a foodstuff having a protein:energy ratio of from 40 to 60%, a carbohydrate:energy ratio of 25% or less and a fat:energy ratio of from 15 to 60%, wherein the energy ratios are based on the total energy content of the foodstuff. In the present text, the phrase “a method of ensuring the acceptance of a foodstuff” also includes a method of increasing the acceptance of a foodstuff. Also, in the present text, the term “acceptance” also includes enjoyment (i.e. enjoyment of a foodstuff).

The foodstuffs are preferably a food product in their own right. Each may be a dry, semi-moist or a moist (wet) product. Wet food includes food that is usually sold in a container, such as a tin, pouch or tray and has a moisture content of 70% to 90%. Dry food includes food having a similar composition but with 5% to 15% moisture, often presented as small biscuit—like kibbles. Semi-moist food includes food having a moisture content of from above 15% up to 70%. The amount of moisture in any product may influence the type of packaging that can be used or is required. The food product, of any moisture level may be ready-to-eat.

The foodstuff encompasses any product that a cat consumes in its diet. Thus, the foodstuff may include the standard food products as well as food products for companion animals, such as food snacks (for example snack bars, cereal bars, snacks, treats, biscuits and sweet products). The foodstuff may be a cooked product. It may incorporate meat or animal-derived material (such as beef, chicken, turkey, lamb, fish, blood plasma, marrowbone, etc or one or more thereof). Alternatively the foodstuff may be meat-free (preferably including a meat substitute such as soya, maize gluten or a soya product in order to provide protein). The foodstuff may contain additional protein sources such as soya protein concentrate, milk, protein, gluten, etc. The foodstuff may also contain starch, such as one or more grains (e.g. wheat, corn, rice, oats, barley, etc) or may be starch-free. The foodstuff may incorporate or be a gelatinized starch matrix. The foodstuff may incorporate one or more types of fibre such as sugar beet pulp, chicory pulp, chicory, coconut endosperm fibre, wheat fibre etc. Dairy products, such as those incorporating a cream or a cheese sauce, may be suitable. The foodstuff can also be newly designed products currently not available. The most suitable foodstuff may be a product as described herein which is sold as a pet food, in particular a pet food for a domestic cat. It may be convenient to provide the foodstuff in a dry format, such as dried ready-to-eat cereal products (often referred to as kibbles).

The foodstuff in the first aspect of the invention is preferably nutritionally complete so that the practice of the invention may provide a suitable nutritionally complete diet for the animal.

Optionally, the foodstuff may be multi-component. The multi-component foodstuff may comprise a dried ready-to-eat cereal product. The multi-component foodstuff may only comprise such dried ready-to-eat cereal products. Alternatively, the multi-component foodstuff may comprise a dried ready-to-eat cereal product and a wet or semi-moist product. The individual products within the multi-component foodstuff need not necessarily have the macronutrient content specified according to this invention. However, the total food compositions of the multi-component foodstuff must have the macronutrient content according to this invention (PER of 40 to 60%, FER of 15 to 60% and CER of 25% or less). The multi-component foodstuff may comprise individual packages of food which, when all individual packages are fed over a period of time, such as 1 day, 2 days or one week, provide the macronutrient content according to the invention. The individual products may be packaged as discussed below.

The foodstuff is preferably packaged. In this way the consumer is able to identify, from the packaging, the ingredients and macronutrient content of the product and confirm that it is suitable for the particular animal in question. The packaging may be metal (usually in the form of a tin or flexifoil), plastic (usually in the form of a pouch or bottle), paper or card. The amount of moisture in any product may influence the type of packaging, which can be used or is required. The foodstuff may be available as a “kit” or “pack” wherein different or the same food compositions are individually packaged and these packages are somehow joined together, for example in a box and/or with overarching packaging for the two or more packages of food compositions. The individually packaged foodstuffs may fall within the macronutrient content according to the invention. Alternatively, the combined individual packets of foodstuff (in the form of a multi-component foodstuff) may provide the macronutrient content according to the invention. In this case, the combined individual packets of foodstuff may provide the macronutrient content of the invention when fed over a period of time, such as 1 day, 2 days or one week

The ratios of macronutrient profiles of the first aspect of the invention are as follows:

Protein: PER=40 to 60%

Fat: FER=15 to 60%

Carbohydrate: CER=25% or less

All based on PME of the foodstuff.

Wherein PER=energy derived from protein:total energy ratio

FER=energy derived from fat:total energy ratio

CER=energy derived from carbohydrate:total energy ratio

PME=predicted metabolisable energy.

The present invention provides a cat foodstuff, for use in ensuring the acceptance to a cat. Such a selection can be represented by the triangle of FIG. 1 (representing diets of varying macronutrient profile). The method according to the first aspect of the invention allows the animal to ensure acceptance of eating. Ensuring the acceptance of eating may optimise the acceptance of eating.

In aspects of the invention which describe “feeding”, it is meant allowing the animal access to the foodstuff of the invention to feed from.

The present invention is based on the observation that when consuming food, animals are attempting to reach a target intake of each of the three macronutrients (protein, carbohydrate and fat) within a given time period. The invention describes a foodstuff which allows cats to have immediate access to their preferred foodstuff.

The invention provides a solution to the problem of providing palatable foods for animals, as well as offering benefits to the animal of ensuring acceptance in feeding. Furthermore the invention provides an increased enjoyment/satisfaction by the carer/owner of a pet (companion) animal.

The enjoyment of the animal and/or increase in acceptance/palatability can be determined, for example, by one or more of the following:

an increase in the quantity of foods consumes;

a decrease in the frequency of refusals to eat over an extended period of time;

an increase in enthusiasm during the meal as indicated by a reduction in the time taken to start a meal and/or an increase in the speed at which food is consumed;

the animal chooses the food over another food;

the animal refuses other foods;

or by any other behaviour by a pet animal which is taken by the owner/carer to be an indication of enjoyment of the food, for example:

the animal rubs around the owner/carer when serving the food;

the animal is inactive/rests or sleeps after eating;

the animal licks itself or washes after eating.

Preferably, the protein:energy ratio of the foodstuff is not less than 50%.

The preferred carbohydrate:energy ratio is from not more than 20% or is not more than 15%, or not more than 10%. A suitable range is from 5 to 15%.

The preferred fat:energy ratio is not more than 50%.

The present invention, in particular, relates to ensuring long-term acceptance of the foodstuff to a cat. By long term is meant any period from 2 to 7 days, 2 or 4 weeks.

In accordance with the second aspect of the invention, there is provided the use of a source of fat, protein and optionally carbohydrate, in the manufacture of a foodstuff having a protein:energy ratio of from 40 to 60%, a carbohydrate:energy ratio of 25% or less and a fat:energy ratio of from 15 to 60%, wherein the energy ratios are based on the total energy content of the foodstuff, to increase the acceptance of a foodstuff to a cat.

All preferred features of the first aspect of the invention, also apply to the second.

### BRIEF DESCRIPTION OF THE DRAWINGS

The present invention is described with reference to the figures, in which:

FIG. 1 is a representation, graphically, of the macronutrient content of food. The foodstuff of the present invention is shown as the shaded target area.

FIG. 2 is a chart of mean cycle intakes of food over time.

FIG. 3 is a graph of group mean food intake (g/day) over time.

FIG. 4 is a graph of group mean % of total eaten per day over time.

FIG. 5 is a graph of individual mean % of total eaten during the experienced self-selection phase. The initial of each cat's name (or first two letters) is shown.

FIG. 6 is a graph of group mean food intake (g/day) over time.

FIG. 7 is a graph of group mean % of total eaten per day over time.

FIG. 8 is a graph of individual mean % of total eaten during the experienced self-selection phase. The initial of each cat's name (or first two letters) is shown.

FIG. 9 is a graph of intake (g/cat/day) over time (in days).

FIG. 10 is a graph of energy ratio (%), of diet over time (in days).

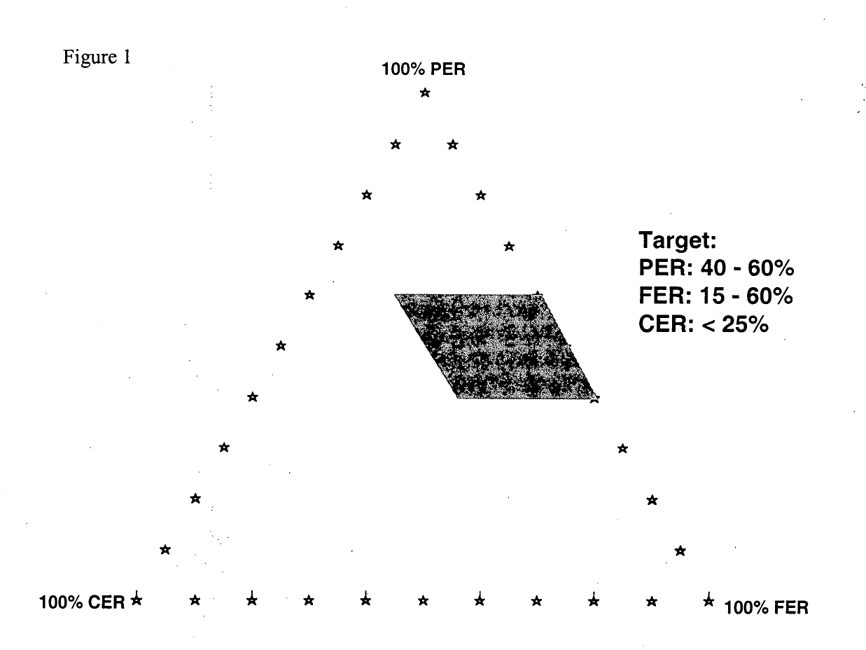

### DETAILED DESCRIPTION OF THE INVENTION

### EXAMPLE 1

### Effect of Macronutrient Profile on the Acceptance of Wet Cat Food: to Investigate the Effects of Varying Carbohydrate, Fat and Protein Energy Ratios

Summary

This trial consisted of a group cats (n=10) who were fed 3 homogenized diets designed to have different macronutrient profiles. The diets were prepared using processed chicken breast, lard and wheat flour to achieve diets high in protein, fat or carbohydrate. All of the cats were naïve to the diets.

This study followed a trial based on feeding a diet, which was designed to introduce the cats to this homogenized, “porridge-type” diet format. This trial followed the feeding regime: 7-days “naïve” self-selection (3-way preference) followed by 24-days of monadic learning (one diet per day) and finally 7-days “experienced” self-selection (3-way preference). Cats had approximately 22 hours access to food every day during the trial. Two of the ten cats did not complete the trial and have not been included in the analyses.

During the naïve self-selection phase it was found that the high protein diet was preferred compared to the high fat and high carbohydrate diets (mean intake 160.7 g). During the learning phase it was found that the cats were prepared to eat the high carbohydrate diet in the absence of choice (mean 121.4 g), but intakes of the high protein diet and high fat diet were greater. The experienced self-selection response of the cats to the 3 diets was that the high protein diet was preferred (mean intake 194.4 g) to the high carbohydrate and high fat diets (Table 2). There was a clear increase in fat consumption between the naïve and experienced self-selection.

Investigation of the mean energy intakes of PER/FER/CER in the naïve self-selection phase showed cats consumed 50.2% PER, 42.3% FER, 7.5% CER. The same analysis of PER/FER/CER during the experienced self-selection phase showed the mean energy intakes to be 48.6% PER, 46.9% FER, 4.5% CER (Table 4). The high protein diet appeared to be preferred to the other two diets during all three phases.

The mean percentage change in bodyweight during the trial was −0.9%, for the cats that completed the study.

Background

A previous series of trials sought to establish whether the response to the macronutrient profile of dry diets could be modified by a period of monadic learning. Pilot studies investigated the effect of three extremes of macronutrient in the diets: high fat, high protein or high carbohydrate. Trials using committed dry feeding cats, investigated feeding preferences when a single macro-nutrient was present at similar levels and two other macro-nutrients were offered at variable levels. The dry diets were a biscuit kibble format and as such there was a requirement for the inclusion of carbohydrates in the recipe, so although it was possible to reduce this to around 25 to 30%, it could not be totally removed.

The aim of this study was to assess wet diets with extreme macronutrient profiles: high protein, high fat or high carbohydrate energy ratios (Table 1), the composition of the wet diets also allowed us to reduce the carbohydrate levels further (0%), than had been possible in dry diets.

Animals

Cats (n=10) were selected from cats previously fed on a diet of a similar format to the trial diet. The cats were individually housed and socialised as a group every day.

Diets

Three homogenized model diets comprising of processed chicken breast meat, lard and wheat flour, with the addition of minerals and vitamins to meet NRC guidelines, were made fresh each day. The diet recipes were all designed to contain predicted levels of PER, FER, CER. One diet was enriched with protein, one with fat and one with carbohydrate. Samples of the trial diets were taken on 3 consecutive days in phase 2, the protein, fat, ash and moisture content of each diet were analyzed and calculated to provide the ratio of each macronutrient relative to the total energy (PME) of each diet: PER/FER/CER (Table 1).

TABLE 1
PME and macronutrient energy ratios for trial diets.

| | Actual proximate | | | | | | |
|---|---|---|---|---|---|---|---|
| | analysis | | | | Energy | | |
| | Protein | Fat | | PME | Ratio (%) | | |
| | (g) | (g) | CHO (g) | (kcal) | PER | FER | CER |
| Diet G | 6.6 | 3.8 | 12.7 | 88 | 27.7 | 31.4 | 40.9 |
| (High CHO) | | | | | | | |
| Diet J | 7.3 | 11.6 | 0 | 113 | 24.9 | 75.1 | 0 |
| (High Fat) | | | | | | | |
| Diet H | 16.1 | 3.4 | 0 | 88 | 70.7 | 29.3 | 0 |
| (High Protein) | | | | | | | |

Feeding Regime

The feeding protocol consisted of 3 phases.

Phase 1: Naïve self selection/3-way preference phase (7-days). Each cat received ad libitum access to water and all 3 diets: 190 g of each diet was offered at 10.30 am and replaced by a further 190 g at 3.30 pm which was left in the lodge until 8.30 am next day, giving each cat 22 hours exposure. This feeding cycle was repeated for 7 days. The position of the diets was rotated daily to avoid positional bias.

Phase 2: Learning/monadic phase (24-days). Each cat received a single test diet each day (ad libitum in 2 meals). Cats were randomly assigned to one of 6 groups with each group receiving the diets in a different rotation sequence in a 3-day cycle. Each cat therefore experienced each experimental diet 8 times.

Phase 3: Experienced self-selection/3-way preference (7-days). As phase 1, but having had experience of the diets.

For all three phases the food intakes were recorded manually every time food was replaced.

Results and Data Analysis

Of the 10 cats that started, 8 completed the study. Two cats did not complete the study due to unrelated health reasons.

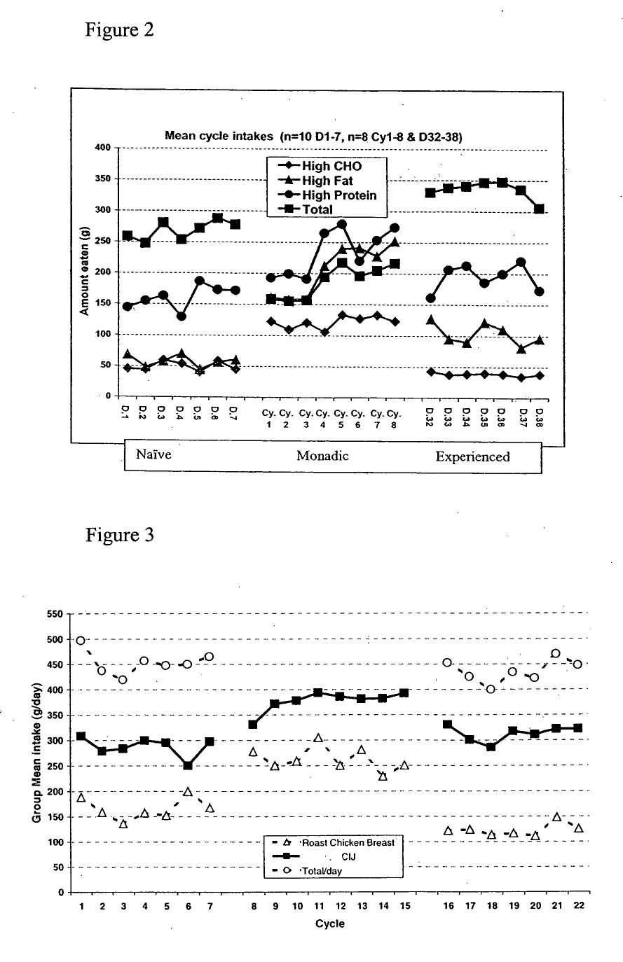

FIG. 2 is a chart which shows the mean cycle intakes throughout the trial. The three phases are identified as:

Naïve=Days 1 to 7

Learning=Cycles 8 to 15

Experienced=Days 32 to 38.

It is clear from this chart that the cats having sampled all the diets during the naïve phase of self-selection, rejected the high carbohydrate and high fat diets in favour of the high protein. The preferred diet was the high protein for all three phases, although the high fat diet had an increased acceptance in the experienced phase compared to the naïve phase. Total mean intakes per cycle in the monadic phase were reduced compared with the self-selection phases, but they started to improve after 3 exposures to all of the diets due to an increased intake of the high protein and high fat diets, whilst the high carbohydrate diet intakes were unchanged.

Naïve Self-Selection Phase:

Statistical analyses show that there is a significant different between diets G & J, and diet H (ANOVA, p<0.001).

Learning Phase:

Statistical analyses show that there is a significant difference between the 3 diets (ANOVA a, p<0.001). Multiple range tests also shows that diets G, H and J are significantly different from each other.

Experienced Self-Selection Phase:

Statistical analyses show that there is a significant difference between the 3 diets (ANOVA, p<0.001). Multiple range tests shows that diets G, H and J are significantly different from each other.

When analyzing the intake data for the individual cats in the experienced self-selection phase, it was apparent that one cat was significantly different to the rest of the cats for each diet; with higher intakes of the high fat diet and lower intakes of the high protein and high carbohydrate diets. Other cats also had significantly different intakes to the group. One who had higher intakes of the high carbohydrate diet and one who had higher intakes of the high protein diet.

TABLE 2
Mean daily intake, grams per diet.

| | Phase 1 | Phase 2 | Phase 3 |
|---|---|---|---|
| | Naïve self- | Learning/ | Experienced |
| | selection | Monadic | self-selection |
| | (3 diets offered) | (one diet offered) | (3 diets offered) |
| Diet G | 49.5 | 121.4 | 37.9 |
| (High CHO) | | | |
| Diet J | 58.0 | 212.3 | 102.7 |
| (High Fat) | | | |
| Diet H | 160.7 | 240.4 | 194.4 |
| (High Protein) | | | |

It was anticipated that the carbohydrate diet would be rejected in favour of the other two diets, but in fact even when given the opportunity to select from all three diets, the cats still consumed some of the high carbohydrate diet.

TABLE 3
Mean daily intake of macro-nutrient.

| | | Learning/ | | | |
|---|---|---|---|---|---|
| | Phase 1 | Phase 2 | | | Phase 3 |
| | Naïve | Monadic | | | Experienced |
| | self-selection | Diet G | Diet J | Diet H | self-selection |
| Protein (g/day) | 33.3 | 8.0 | 15.1 | 37.6 | 33.7 |
| Fat (g/day) | 14.0 | 4.6 | 23.8 | 7.9 | 27.0 |
| CHO (g/day) | 6.3 | 15.4 | 0.0 | 0.0 | 4.8 |

Bodyweights of the cats were measured on day one of trial, and thereafter twice weekly. The mean percentage change in bodyweight from the start of the trial to the end of the trial was −0.3%. There was an overall weight-loss during the monadic phase, up to −2.7% but this was recovered during the experienced phase. Two cats, still had reduced bodyweight at the end of the trial but as they were large cats there was no change in body condition score. This indicated that in a monadic feeding situation, the cats would east less of the high carbohydrate diet than was required to maintain bodyweight, rather than overload on carbohydrate intake.

P/F/CER Selection as a Potential Driver of Macronutrient Selection

The mean PER intake was calculated for each cat for each from the food intake data, using the following calculation:

$$\begin{matrix}Mean PER eaten pe \frac{{\sum }_{Over all 3 test diets} ( \begin{matrix}Amount of test diet eaten ( g ) \times \\ PER of test diet\end{matrix} )}{Total amount eaten {( g )}^{*}} \\ \begin{matrix}{}^{*} For self \text{-} selection phase \\ ( na \ddot{i} ve / experienced )\end{matrix} = sm of 3 test diets eaten per day ( g ) . \\ {}^{*} For learning phase = sum of 3 test diets eaten over 3 \text{-} day cycle ( g )\end{matrix}$$

Thus the mean percentage daily, per cycle, PER/FER/CER intake was calculated (Table 4).

TABLE 4
Mean cycle PER, FER and CER intake for each phase.

| | | Phase 2 | Phase 3 |
|---|---|---|---|
| | Phase 1 Naïve | Learning/ | Experienced |
| | self-selection | Monadic | self-selection |
| PER (%) | 50.2 | 40.8 | 48.6 |
| FER (%) | 42.3 | 45.5 | 46.9 |
| CER (%) | 7.5 | 13.6 | 4.5 |

### EXAMPLE 2

Regulation of Macronutrient Intake in Cats

Rationale

A series of trials have been carried out investigating the long term feeding responses of cats to the macronutrient profile of wet diets. Results from these trials identified that adult cats have a target or preferred macronutrient intake. Based on this information, a canned cat food (meaty chunks in jelly) product was formulated to fall within the target macronutrient intake range for adult cats and these trials compared the feeding performance of this product with novel human foods; namely freshly roasted chicken breast and canned cod fillet. Each of these human foods were chosen as they are commonly believed to be highly palatable to cats and also have a higher PER than the product formulated to fall within the target macronutrient range. We hypothesized that, after an appropriate period of learning, cats would display a preference for the product formulated to fall within the target macronutrient range over the foods offered to them that do not satisfy their target macronutrient intake despite the perceived hedonic attraction of those foods. The cats (n=12 per study) were fed using an established methodology developed for investigating long term feeding responses.

Diets

The first diet (A) was freshly roasted chicken breast. The chicken breasts were roasted with the skin on but the skin was removed prior to feeding. The second diet (B) was canned cod fillet. This was cubed pieces of cod. The third diet (W) was a canned cat food formulated using a meaty chunks in jelly recipe to contain a PER/FER and CER within the currently accepted target range for adult cats. Further details of the diets are listed in the following table:

| | | Protein/Fat/ |
|---|---|---|
| Diet | | CHO Energy Ratios |
| Code | Diet Type | (PER/FER/CER) |
| A | Fresh Roast Chicken | 82/18/0 |
| B | Canned Cod Fillet | 92/8/0 |
| W | CIJ recipe at 55% PER | 53/43/4 |

Feeding Protocol

The feeding protocol for each study consisted of 3 different feeding regimes: an initial self-selection phase (7 days), a monadic phase (16 days) and a final self-selection phase. During the self-selection phases (naïve and experienced), the cats had ad libitum access to both experimental diets for approximately 22 hours per day. During the monadic phase, the cats each received ad libitum access to a single test diet for approximately 22 hours each day. To avoid positional bias the diets were rotated daily.

Results

Effect of Macronutrient profile on diet selection in cats; Fresh Roast Chicken vs. canned cat food (meaty chunks in jelly) recipe within target macronutrient range

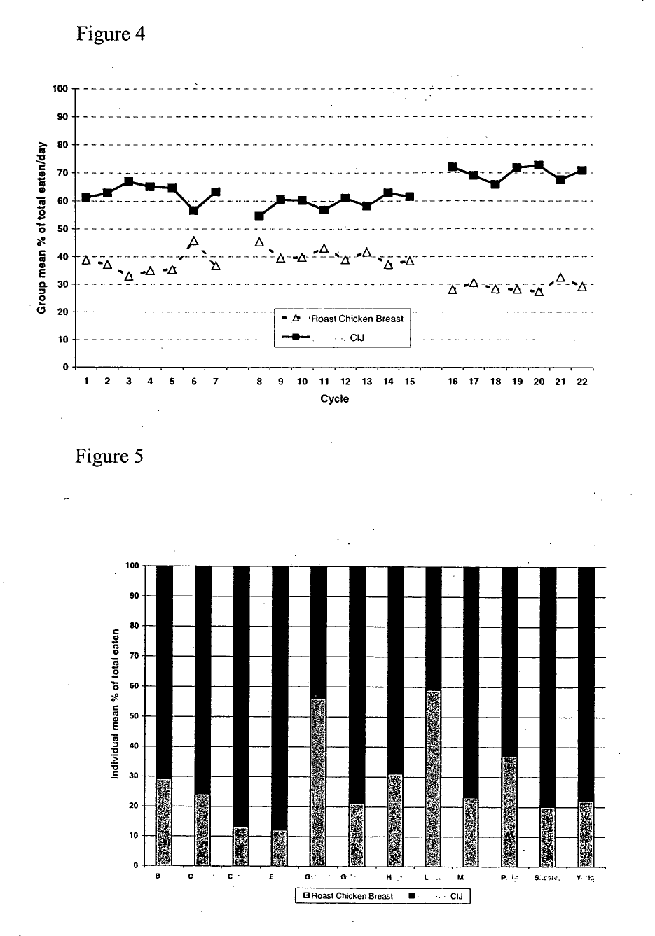

Throughout all phases of the trial, cats displayed a preference (measured as amount eaten in g/day) for the canned cat food (meaty chunks in jelly) diet formulated to be within the target macronutrient range for adult cats over the roast chicken. However this preference was markedly more pronounced in the experienced self-selection phase compared with the naïve self-selection phase (see FIG. 3) where cats ate approximately two and a half times of the canned cat food (meaty chunks in jelly) than of the roast chicken. This is also demonstrated in FIG. 4. During the naïve self-selection phase, on average, 37% of the total daily intake was roast chicken and 63% was the canned cat food (meaty chunks in jelly) diet. During the experienced self-selection phase the proportion of the total daily intake of the canned cat food (meaty chunks in jelly) diet increased to 70% and that of the roast chicken decreased to 30%.

During the naive self-selection phase, 8 out of the 12 cats showed an individual preference (greater than 60:40 ratio) for the canned cat food (meaty chunks in jelly) diet formulated to be within the target macronutrient range for adult cats over the roast chicken. Two out of the 12 cats showed a preference for the roast chicken and the two remaining cats showed no distinct preference for either diet in this phase. During the monadic phase, 5 out of the 12 cats showed a preference for the canned cat food (meaty chunks in jelly) diet formulated to be within the target macronutrient range for adult cats over the roast chicken. The remaining 7 cats showed no preference for either diet in this phase. During the experienced self-selection phase, 10 out of the 12 cats showed an individual preference for the canned cat food (meaty chunks in jelly) diet formulated to be within the target macronutrient range for adult cats over the roast chicken (see FIG. 5). The two remaining cats showed no distinct preference for either diet in this phase. None of the cats showed a preference for the roast chicken in this phase.

Effect of Macronutrient profile on diet selection in cats; Canned Cod vs. canned cat food chunks (meaty in jelly) recipe within target macronutrient range

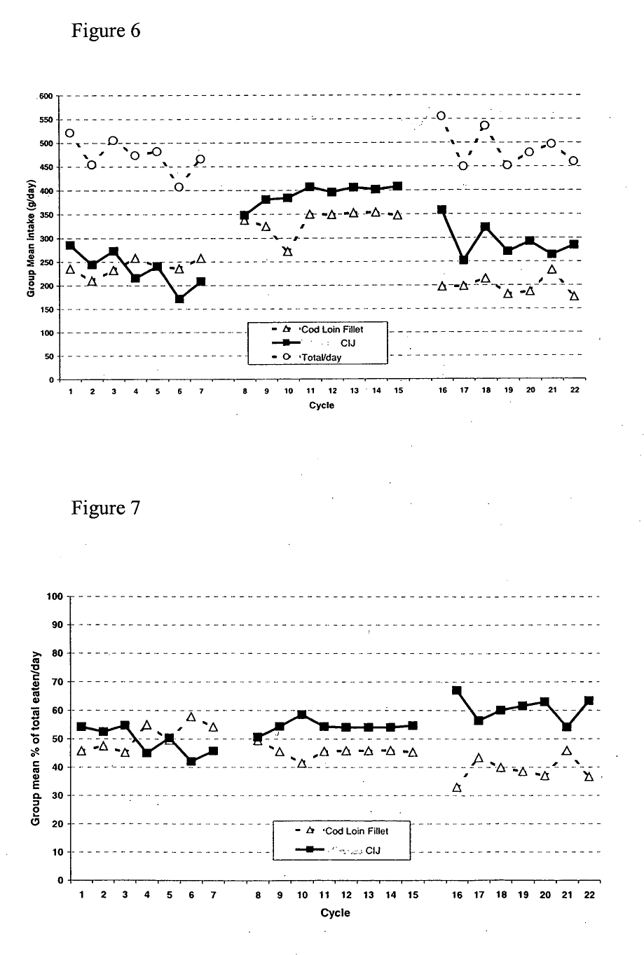

Cats displayed no preference for either diet (amounts eaten being approximately the same) during the naïve self-selection phase (see FIG. 6). During the monadic phase, intake of the canned cat food (meaty chunks in jelly) diet was slightly higher than that of the cod fillet. Importantly, during the experienced self-selection phase, intakes of the canned cat food (meaty chunks in jelly) diet were one and a half times higher than that of the cod fillet. This is also demonstrated in FIG. 7. During the naïve self-selection phase, on average, 51% of the total daily intake was cod fillet and 49% was the canned cat food (meaty chunks in jelly) diet. During the experienced self-selection phase the proportion of the total daily intake of the canned cat food (meaty chunks in jelly) diet increased to 61% and that of the cod fillet decreased to 39%.

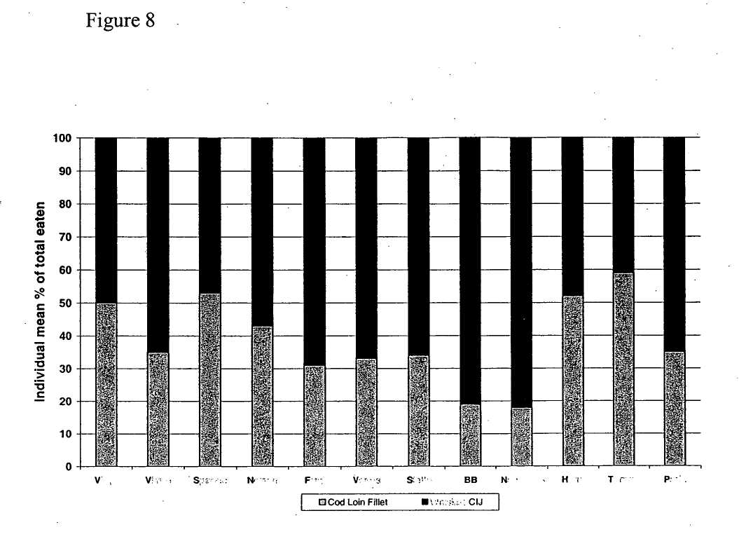

During the naive self-selection phase, 3 out of the 12 cats showed an individual preference (greater than 60:40 ratio) for the canned cat food (meaty chunks in jelly) diet formulated to be within the target macronutrient range for adult cats over the cod fillet. Four out of the 12 cats showed a preference for the cod fillet and the five remaining cats showed no distinct preference for either diet in this phase. During the monadic phase, 1 out of the 12 cats showed a slight preference for the canned cat food (meaty chunks in jelly) diet formulated to be within the target macronutrient range for adult cats over the cod fillet and 1 out of the 12 cats showed a slight preference for the cod fillet. The remaining ten cats showed no preference for either diet in this phase. During the experienced self-selection phase, 7 out of the 12 cats showed an individual preference for the canned cat food (meaty chunks in jelly) diet formulated to be within the target macronutrient range for adult cats over the cod fillet (see FIG. 8). The five remaining cats showed no distinct preference for either diet in this phase. None of the cats showed a preference for the cod fillet in this phase.

Conclusions

After an appropriate period of learning, the majority of cats showed a preference for the canned cat food (meaty chunks in jelly) diet formulated to be within the target macronutrient range for adult cats over the roast chicken or the cod fillet, both of which were outside of the target macronutrient range.

During the experienced self-selection phase, intakes of the canned cat food (meaty chunks in jelly) diet were two and a half times higher than that of the roast chicken.

During the experienced self-selection phase, intakes of the canned cat food (meaty chunks in jelly) diet were one and a half times higher than that of the cod fillet.

On average, during the experienced self-selection phase, the proportion of the total daily intake was 70:30 canned cat food (meaty chunks in jelly) to roast chicken and 61:39 canned cat food (meaty chunks in jelly) to cod fillet.

### EXAMPLE 3

Regulation of Macronutrient Intake in Cats

Diets of a typical Protein, Fat and Carbohydrate energy ratio (PER, FER and CER), as detailed in table 5 (see below), have been fed in a self-selection regime to a group of twelve adult cats for a period of approximately 11 months.

TABLE 5
Typical diet compositions fed in a long-term self-selection test

| | PER | FER | CER |
|---|---|---|---|
| High Carbohydrate | 41 | 28 | 31 |
| High Protein | 68 | 29 | 3 |
| High Fat | 39 | 54 | 7 |

The animals have been allowed ad libitum access to all three of these diets at each meal in order that they may individually regulate their intake of these diets such that they are able to satisfy their target macronutrient intake on a day by day basis.

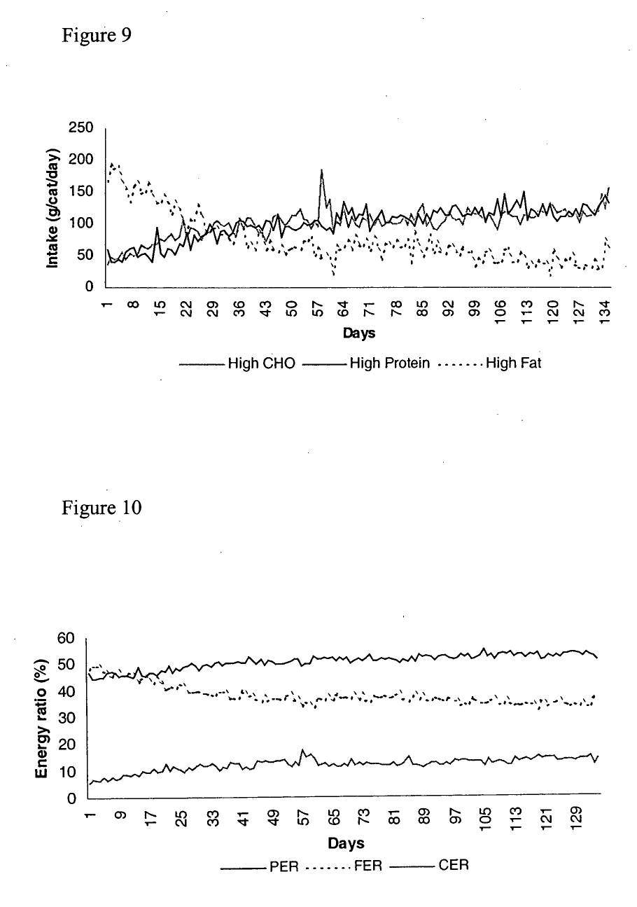

The evolution of the intake of each diet over time and of PER/FER/CER over time are shown in FIGS. 9 and 10 respectively.

At the start of the study, the cats were naïve to these diets and so made a selection based on the hedonics of the diets consuming more of the high fat diet than of the high protein or high carbohydrate diets. Over time the cats learnt about the nutritional composition of the foods and intake of the high protein and high carbohydrate diets increased and the intake of the high fat diet decreased. After approximately 35 days, intakes of the high protein and high fat diets were higher than that of the high fat diets. This diet selection became more pronounced over the next 15 days and then remained remarkably stable from day 50. This diet selection continues to show considerable stability. Over the same time scale, the PER, FER and CER chosen by the cats reflects these changes in diet selection. Once the cats had demonstrated nutritional learning and their diet selection had stabilized, the PER, FER and CER chosen by the cats was approximately 52/36/12.

It will be appreciated by persons skilled in the art that numerous variations and/or modifications may be made to the invention as shown in the specific embodiments without departing from the spirit or scope of the invention as broadly described, the present embodiments are, therefore, to be considered in all respects as illustrative and not restrictive.

1. A method of ensuring the long-term acceptance of a foodstuff to a cat, the method comprising feeding to said cat, a foodstuff having a protein energy ratio of from 40 to 60%, a carbohydrate energy ratio of 25% or less and a fat energy ratio of from 15 to 60%, wherein the energy ratios are based on the total energy content of the foodstuff.

2. A method as claimed in claim 1, wherein the protein energy ratio is not less than 50%.

3. A method as claimed in claim 1, wherein the carbohydrate energy ratio is not more than 20%, or is not more than 15%, preferably 5 to 15%.

4. A method as claimed in claim 1, wherein the fat energy ratio is not more than 50%.

5. A method as claimed in claim 1, wherein the foodstuff is a wet, semi-moist or dry foodstuff.

6. A method to manufacture a foodstuff having a protein energy ratio of from 40 to 60%, a carbohydrate energy ratio of 25% or less and a fat energy ratio of from 15 to 60%, wherein the energy ratios are based on the total energy content of the foodstuff, to ensure the acceptance of a foodstuff to a cat, comprising the steps of: providing a source of fat, protein and optionally carbohydrate; and manufacturing the foodstuff from said provided source.

7. A method as claimed in claim 6, wherein the protein energy ratio is not less than 50%.

8. A method as claimed in claim 6, wherein the carbohydrate energy ratio is not more than 20%.

9. A method as claimed in claim 6, wherein the fat energy ratio is not more than 50%.

10. A cat foodstuff, for ensuring the acceptance to a cat comprising a foodstuff having a protein energy ratio of from 40 to 60%, a carbohydrate energy ratio of 25% or less and a fat energy ratio of from 15 to 60%, wherein the energy ratios are based on the total energy content of the foodstuff.

11. A method as claimed in claim 8 wherein the carbohydrate energy ratio is not more than 15%.

12. A method as claimed in claim 11, wherein the carbohydrate energy ratio is preferably 5 to 15%.
